(19) United States
(12) Patent Application Publication
(10) Pub. No.: US 2025/0022233 A1
(43) Pub. Date: Jan. 16, 2025

(54) AUGMENTED REALITY DISPLAY APPARATUS, SERVER APPARATUS, AUGMENTED REALITY DISPLAY SYSTEM, AUGMENTED REALITY DISPLAY METHOD, AND PROGRAM

(71) Applicant: NEC Corporation, Minato-ku, Tokyo (JP)

(72) Inventors: Shin NORIEDA, Tokyo (JP); Yoshiyuki TANAKA, Tokyo (JP); Shogc AKASAKI, Tokyo (JP); Maki KUROKAWA, Tokyo (JP); Kazuki EGUCHI, Tokyo (JP); Koji SHINOZAKI, Tokyo (JP); Yuji NAKAJIMA, Tokyo (JP)

(73) Assignee: NEC Corporation, Minato-ku, Tokyo (JP)

(21) Appl. No.: 18/711,948

(22) PCT Filed: Nov. 22, 2022
(86) PCT No.: PCT/JP2022/043117

§ 371 Date: May 21, 2024

(30) Foreign Application Priority Data
Nov. 24, 2021 (JP) 2021-189898

(51) Int. Cl. G06T 19/00; G06Q 50/00; G06V 10/44

(52) U.S. Cl. CPC G06T 19/006; G06Q 50/01; G06V 10/44

(57) ABSTRACT

Augmented reality display apparatus includes: display part; image analysis part that detects shooting target object feature amount digitizing feature point of shooting target object included in image data; and control part, wherein control part transmits post download instruction information including shooting position information relating to shooting position of image data and shooting target object feature amount to a server apparatus; and causes display part to overlay post data at relative position to shooting target object feature amount in image data displayed on the display part based on information relating to post data associated with shooting position information and shooting target object feature amount transmitted from the server apparatus. Relative position to shooting target object feature amount is position based on post position information included in information relating to post data (FIG. 13).

### TECHNICAL FIELD

### Description of Related Application

The present invention is based on claiming priority of Japanese Patent Application: JP2021-189898 (filed on Nov. 24, 2021), the entire contents of the present application shall be incorporated and stated in the present application by reference thereto.

The present invention relates to an augmented reality display apparatus, a server apparatus, an augmented reality display system, an augmented reality display method, and a program.

### BACKGROUND ART

There is an information sharing service using augmented reality (AR) technology that overlays related post data (photos, text, etc.) at a predetermined position in a real image shot by a camera on a mobile terminal (e.g., smartphone). In the information sharing service using AR technology, a mobile terminal transmits current location information based on a GPS (Global Positioning System), etc., and azimuth information obtained from an azimuth sensor, etc. to a server apparatus; acquires the posted data posted in a surrounding position of the current position information and the azimuth information from the server apparatus; and overlays the post data at a designated position (designated position set in the post data) in the image shot by the camera (for example, see Patent literatures (PTLs) 1 to 3).

### CITATION LIST

### Patent Literature

[PTL 1] JP2014-006582A
[PTL 2] JP2013-231655A
[PTL 3] JP2011-123807A

### SUMMARY

### Technical Problem

Each disclosure of the above prior art literatures is incorporated herein by reference thereto. The following analysis has been performed by the inventors.

In the information sharing services using AR technology described in PTLs 1 to 3, due to a problem of accuracy of a position measured by GPS in the mobile terminal, it was difficult to display post data in a detailed position such as a specific object (for example, servers located indoors, etc.) in the image shot by the camera in the mobile terminal. For example, in case that there are servers A and B of the same model in two adjoining rooms in an office building, it is impossible to determine whether the server in the image is server A or server B using only the image of the server, and there is a possibility that posted data posted to the server A will be displayed around server B. In other words, in the information sharing services using AR technology described in PTLs 1 to 3, it is impossible to display post data in an accurate position, and there is a possibility that a user will not be able to obtain the information the user wants.

It is a main object of the present invention to provide an augmented reality display apparatus, a server apparatus, an augmented reality display system, an augmented reality display method, and a program that can contribute to causing to display post data at an accurate position in a shot image.

### Solution to Problem

An augmented reality display apparatus according to a first aspect comprises: a display part configured to display information; an image analysis part configured to analyze image data and detect a shooting target object feature amount that digitizes at least one feature point of a shooting target object included in the image data; a control part configured to control the display part and the image analysis part and perform predetermined information processing, wherein the control part is configured to perform processings of: transmitting post download instruction information including shooting position information relating to a shooting position of the image data and the shooting target object feature amount to a server apparatus; and causing the display part to overlay the post data at a relative position to the shooting target object feature amount in the image data displayed on the display part based on information relating to the post data associated with the shooting position information and the shooting target object feature amount transmitted from the server apparatus, and wherein the relative position to the shooting target object feature amount is a position based on the post position information included in the information relating to the post data.

A server apparatus according to a second aspect comprises: a storage part configured to associate and store: shooting position information relating to a position at which image data was shot; a shooting target object feature amount that digitizes at least one feature point of a shooting target object included in the image data; and information relating to post data including post position information relating to a relative position to the shooting target object feature amount; and a control part configured to control the storage part and perform a predetermined information processing, wherein when acquiring post download instruction information from an augmented reality display apparatus, the control part is configured to perform processings of: reading information relating to the post data associated with shooting position information and shooting target object feature amount included in the post download instruction information from the storage part; and transmitting the read information to the augmented reality display apparatus.

An augmented reality display system according to a third aspect comprises: the augmented reality display apparatus according to the first aspect; and the server apparatus according to the second aspect.

An augmented reality display method according to a fourth aspect comprises: transmitting post download instruction information including shooting position information relating to a shooting position of an image data, and post download instruction information including a shooting target object feature amount obtained by analyzing the image data and digitizing at least one feature point of a shooting target object included in the image data, from an augmented reality display apparatus to a server apparatus; reading information relating to post data associated with the shooting position information and the shooting target object feature amount included in the post download instruction information from a storage part of the server apparatus, when acquiring the post download instruction information, to transmit the read information to the augmented reality display apparatus, in the server apparatus; and causing the augmented reality display apparatus to overlay the post data at a relative position to the shooting target object feature amount in the displayed image data based on information relating to the post data transmitted from the server apparatus, wherein the relative position to the shooting target object feature amount is a position based on the post position information included in the information relating to the post data.

A program according to a fifth aspect causes an augmented reality display apparatus to execute processings of: transmitting post download instruction information including shooting position information relating to a shooting position of an image data, and a shooting target object feature amount obtained by analyzing the image data and digitizing at least one feature point of a shooting target object included in the image data, to a server apparatus; and causing to overlay the post data at a relative position to the shooting target object feature amount in the displayed image data based on information relating to post data associated with the shooting position information and the shooting target object feature amount transmitted from the server apparatus, wherein the relative position to the shooting target object feature amount is a position based on the post position information included in the information relating to the post data.

A program according to a sixth aspect causes a server apparatus to execute processings of: reading information relating to post data associated with shooting position information and shooting target object feature amount included in post download instruction information from a storage part, when acquiring post download instruction information from an augmented reality display apparatus; and transmitting the read information to the augmented reality display apparatus.

### Effects of Invention

According to the first to sixth aspects, it is possible to contribute to causing to display post data at an accurate position in a shot image data.

### BRIEF DESCRIPTION OF THE DRAWINGS

FIG. 1 is a block diagram schematically showing a configuration of an augmented reality display system according to an example embodiment 1.

FIG. 2 is an image diagram schematically showing an example of an augmented reality displayed on an augmented reality display apparatus in the augmented reality display system according to the example embodiment 1.

FIG. 3 is an image diagram schematically showing a relationship between shooting position information and a shooting target object feature amount relating to image data in the augmented reality display system according to the example embodiment 1.

FIG. 4 is a flowchart diagram schematically showing operations relating to registration of post data in the augmented reality display system according to the example embodiment 1.

FIG. 5 is a transition diagram schematically showing an example of a display screen of an augmented reality display apparatus upon registering post data in the augmented reality display system according to the example embodiment 1.

FIG. 6 is a transition diagram following FIG. 5 that schematically shows an example of a display screen of the augmented reality display apparatus upon registering post data in the augmented reality display system according to the example embodiment 1.

FIG. 7 is a transition diagram following FIG. 6 that schematically shows an example of a display screen of the augmented reality display apparatus upon registering post data in the augmented reality display system according to the example embodiment 1.

FIG. 8 is a flowchart diagram schematically showing operations relating to display of post data in the augmented reality display system according to the example embodiment 1.

FIG. 9 is a transition diagram schematically showing an example of a display screen of the augmented reality display apparatus upon displaying post data in the augmented reality display system according to the example embodiment 1.

FIG. 10 is a transition diagram schematically showing an example of display screen of a management apparatus upon deleting post data in the augmented reality display system according to the example embodiment 1.

FIG. 11 is a block diagram schematically showing a configuration of an augmented reality display system according to an example embodiment 2.

FIG. 12 is a transition diagram schematically showing an example of a display screen of an augmented reality display apparatus upon linking post data in the augmented reality display system according to the example embodiment 2 to an SNS.

FIG. 13 is a block diagram schematically showing a configuration of an augmented reality display apparatus according to an example embodiment 3.

FIG. 14 is a block diagram schematically showing a configuration of hardware resources.

### EXAMPLE EMBODIMENTS

Hereinafter, example embodiments will be described with reference to drawings. It should be noted that when reference numerals are attached to the drawings in the present application, they are solely for a purpose of helping understanding, and are not intended to limit the example embodiments shown in the drawings. Also, the following example embodiments are only examples, and do not limit the present invention. Further, connection lines between blocks in the drawings and the like referred to in the following description include both bidirectional and unidirectional connections. The unidirectional arrows schematically show flows of main signals (data) and do not exclude bidirectionality. Furthermore, in circuit diagrams, block diagrams, internal configuration diagrams, connection diagrams, etc., disclosed in the present application, an input port and an output port exist at the input end and the output end of each connection line, respectively, although not explicitly shown. The same applies to input/output interface. The program is executed via a computer apparatus, and the computer apparatus comprises, for example, a processor, a storage device, an input apparatus, a communication interface, and a display apparatus as necessary. The computer apparatus is configured to be able to communicate with an internal or external apparatus (including computer) via the communication interface, irrespective of wired or wireless.

### Example Embodiment 1

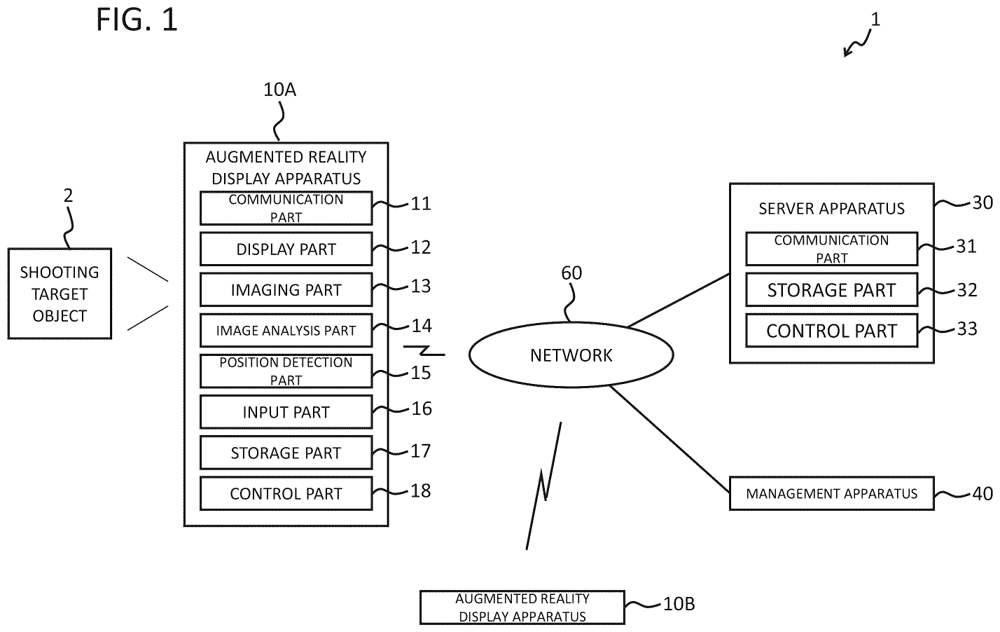

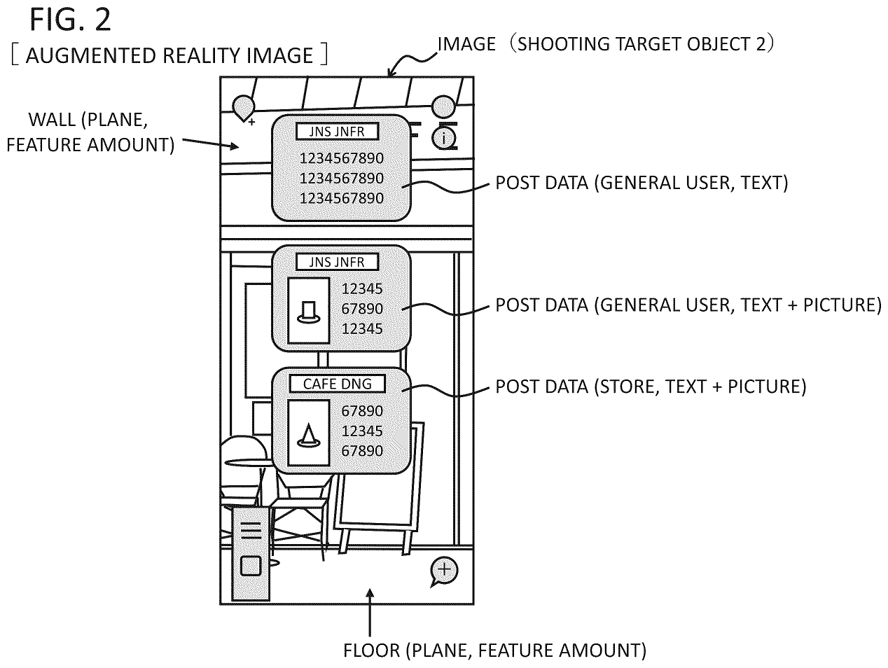

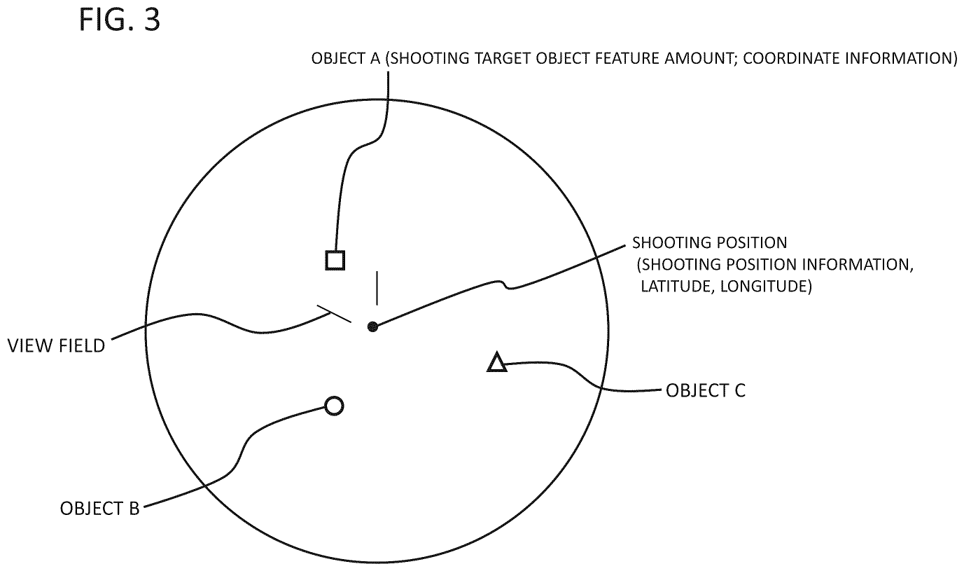

An augmented reality display system according to an example embodiment 1 will be explained using drawings. FIG. 1 is a block diagram schematically showing a configuration of the augmented reality display system according to a first example embodiment. FIG. 2 is an image diagram schematically showing an example of an augmented reality displayed on an augmented reality display apparatus in the augmented reality display system according to the example embodiment 1. FIG. 3 is an image diagram schematically showing a relationship between shooting position information and a shooting target object feature amount relating to image data in the augmented reality display system according to the example embodiment 1.

An augmented reality display system 1 is a system that displays an augmented reality image (AR image) arranging associated post data in an overlapping manner at a predetermined position in real image data (for example, image data obtained by shooting a shooting target object 2) displayed on augmented reality display apparatuses 10A, 10B (see FIGS. 1 and 2). The augmented reality display system 1 has a function of overlaying the post data at a relative position (position based on post position information associated with post data) for the shooting target object feature amount in images displayed on the display apparatuses 10A, 10B based on shooting position information associated with the image data and shooting target object feature amount digitizing at least one feature point of the shooting target object 2 in the image data (see FIG. 3).

Here, as the feature point of the shooting target object 2, for example, a plane, an edge, a corner, etc. of the shooting target object 2 can be listed. Also, as digitizing at least one feature point, for example, providing coordinate information such as three-dimensional coordinate information and polar coordinate information is listed.

The augmented reality display system 1 can be used for information sharing services that share AR images on real space between multiple users, and can be used for, for example, SNS (Social Networking Service), equipment management, maintenance, inventory management, and road information provision, navigation, etc. The augmented reality display system 1 comprises the augmented reality display apparatuses 10A, 10B, a server apparatus 30, a management apparatus 40, and a network 60.

The augmented reality display apparatuses 10A, 10B are apparatuses that display augmented reality images (see FIG. 1). The augmented reality display apparatuses 10A, 10B are communicably (wireless-communicably or wired-communicably) connected to the network 60. Although there are two augmented reality display apparatuses 10A, 10B in FIG. 1, there may be one, or three or more augmented reality display apparatuses. As the augmented reality display apparatuses 10A, 10B, an apparatus (computer apparatus) that comprises function parts (for example, a processor, a storage device, an input device, a communication interface, and a display apparatus) configuring a computer, and capable of acquiring image data associated with the shooting position information can be used, and for example, a smartphone, a tablet terminal, a personal computer, a glasses-type device, etc. can be used. As the image data, image data shot by a imaging part 13 of the augmented reality display apparatuses 10A, 10B, image data stored in a storage part of the augmented reality display apparatuses 10A, 10B, image data acquired from outside (for example, a remote monitoring camera, a location image provision site, etc.) via the network 60, etc. can be used, and the image data may also be associated with azimuth information. The shooting position information associated with the image data may be shooting position information detected by a position detection part 15 of the augmented reality display apparatuses 10A, 10B themselves, shooting position information associated with the image data by another apparatus, etc. The augmented reality display apparatuses 10A, 10B have a time function. The augmented reality display apparatuses 10A, 10B realize a configuration comprising a communication part 11, a display part 12, an imaging part 13, an image analysis part 14, a position detection part 15, an input part 16, a storage part 17 and a control part 18 by executing a predetermined program.

The communication part 11 is a function part that communicates (wired-communicates or wireless-communicates) information (see FIG. 1). The communication part 11 is communicably connected to the network 60. The communication part 11 performs communication under control of the control part 18, as the communication part 11, for example, a wireless communication interface or a wired communication interface may be used.

The display part 12 is a function part that displays information (see FIG. 1). The display part 12 displays information under control of the control part 18. As the display part 12, for example, a display device such as a liquid crystal display or an organic EL (Electro Luminescence) display, a glasses-type display communicably connected to the communication part 11, or the like can be used.

The imaging part 13 is a function part that shoots the shooting target object 2 (see FIGS. 1 and 2). The imaging part 13 generates image data by shooting the shooting target object 2. The imaging part 13 shoots the shooting target object 2 under control of the control part 18. In case the augmented reality display apparatuses 10A, 10B acquire image data from outside, the augmented reality display apparatus 10 may be of a configuration that does not comprise the imaging part 13. As the imaging part 13, for example, an image sensor such as a CCD (Charge Coupled Device) sensor and a CMOS (Complementary Metal Oxide Semiconductor) sensor can be used, and an image sensor further incorporating a three-dimensional sensor (for example, ToF (Time of Flight) camera, stereo camera, 3D-LIDAR (Laser Imaging Detection And Ranging), depth sensor, ranging sensor, distance camera, etc.) for detecting feature amounts may be used. The imaging part 13 may comprise a zoom lens that can shoot telescope or wide-angle images.

The image analysis part 14 is a function part that analyzes image data (see FIG. 1). The image analysis part 14 acquires image data from the imaging part 13, the storage part 17, the communication part 11 (the communication part 11 connected to outside), and the like. The image analysis part 14 analyzes the acquired image data and detects a shooting target object feature amount (three-dimensional coordinate information, polar coordinate information, etc.) digitizing at least one feature point of the shooting target object 2 included in the image data. As a feature amount detection method, a method comprising: extracting a feature point of the shooting target object 2 based on the image data; determining a coordinate of space relating to the image data based on the extracted feature point; and detecting a shooting target object feature amount digitizing at least one feature point based on the determined coordinate can be listed, and, for example, SIFT (Scale-Invariant Feature Transform), HOG (Histograms of Oriented Gradients), etc. can be used.

The position detection part 15 is a function part that detects information (corresponding to shooting position information; for example, longitude and latitude) relating to current positions of the augmented reality display apparatuses 10A, 10B (imaging part 13) (see FIG. 1). The position detection part 15 may detect the shooting position information of the augmented reality display apparatuses 10A, 10B using, for example, GPS (Global Positioning System), radio field strength with multiple wireless base stations for which position information is set in advance, QR (Quick Response) code for which position information is set in advance, etc. In addition to detecting the shooting position, the position detection part 15 may also detect angle information relating to the direction and elevation angle in which an optical axis of the imaging part 13 is directed using a direction sensor, a geomagnetic sensor, an acceleration sensor, etc. In case that the augmented reality display apparatuses 10A, 10B acquire image data associated with shooting position information from outside, the augmented reality display apparatuses 10A, 10B may be of a configuration that does not comprise the position detection part 15.

The input part 16 is a function part that inputs information (see FIG. 1). The input part 16 inputs information input by operation of a user under control of the control part 18. As the input part 16, for example, a touch panel, a keyboard, a mouse, a non-contact UI (User Interface), a gesture sensor, a microphone, a headset, etc. can be used. The input part 16 inputs (selects or specifies is possible) information relating to post data, information relating to filtering conditions, etc. by operation of a user.

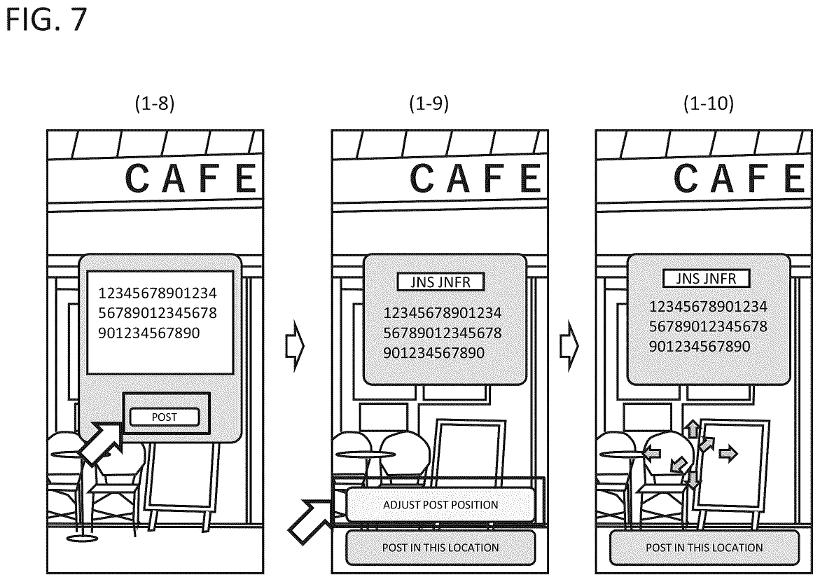

Here, as information relating to post data, for example, user ID, disclosure range (group ID, etc.), posting date and time, display format (balloon, icon display, color, shape, etc.), text (font, letter size, letter color, etc.), emoticons, stamps, images, video files, audio files, hashtags, post position information, etc. can be listed. As to the post position information, it is possible to make a minor adjustment to the position (for example, fine tuning by operating arrow buttons in FIG. 7 (1-10)).

Also, as information relating to filtering conditions, for example, time period (for example, post within one week from today), keywords (for example, “cafe”), hashtags (for example, “#cafe dining”), distance (for example, within 10 meters from current location), user ID, age, gender, group ID, number of positive appreciations (for example, number of goods 10 or more), number of comments, number of questions, etc., can be listed.

The storage part 17 is a function part that stores various information (data, programs, etc.) (see FIG. 1). As the storage part 17, for example, a storage apparatus such as a RAM (Random Access Memory), an SSD (Solid State Drive), or an HDD (Hard Disk Drive) can be used. The storage part 17 writes and reads information under control of the control part 18.

The control part 18 is a function part that controls the communication part 11, the display part 12, the imaging part 13, the image analysis part 14, the position detection part 15, the input part 16, and the storage part 17 (see FIG. 1). As the control part 18, for example, a processor such as a CPU (Central Processing Unit) or an MPU (Micro Processor Unit) can be used. The control part 18 can perform predetermined processings described in a predetermined program by executing the predetermined program stored in the storage part 17.

Upon posting (registering in the server apparatus 30) post data, the control part 18 performs the following processing. The control part 18 acquires image data from the imaging part 13, the storage part 17, the communication part 11 (the communication part 11 connected to outside), etc., and causes the display part 12 to display the image data. The control part 18 acquires the shooting position information (in case that there is angle information, the angle information may be included) from the position detection part 15 or the acquired image data (including the shooting position information). The control part 18 causes the image analysis part 14 to detect a shooting target object feature amount digitizing at least one feature point of the shooting target object 2 based on the acquired image data and acquires the detected shooting target object feature amount. The control part 18 acquires information relating to post data from the input part 16. The control part 18 transmits post upload instruction information associated with information relating to the acquired shooting position information, the shooting target object feature amount and the post data to the server apparatus 30 via the communication part 11 and the network 60.

Upon displaying (including filtering and displaying) post data, the control part 18 performs the following processing. The control part 18 acquires image data from the imaging part 13, the storage part 17, the communication part 11 (the communication part 11 connected to outside), etc., and causes the display part 12 to display the image data. The control part 18 acquires the shooting position information from the position detection part 15 or the acquired image data (including the shooting position information). The control part 18 causes the image analysis part 14 to detect a shooting target object feature amount digitizing at least one feature point of the shooting target object 2 based on the acquired image data and acquires the detected shooting target object feature amount. In case of performing filtering, the control part 18 acquires information relating to filtering conditions from the input part 16. The control part 18 transmits post download instruction information (in case of performing filtering, information also associated with information relating to filtering conditions) including the acquired shooting position information and the shooting target object feature amount to the server apparatus 30 via the communication part 11 and the network 60. The control part 18 acquires information relating to the post data associated with the shooting position information and shooting target object feature amount included in the post download instruction information, which is transmitted from the server apparatus 30 that received the post download instruction information via the network 60 and the communication part 11. The control part 18 causes to overlay the post data at a relative position (position based on the post position information in the information relating to the post data) for the shooting target object feature amount in the image data displayed on the display part 12 based on the acquired information relating to the post data. In case of filtering and displaying post data after displaying the post data, the control part 18 may acquire information relating to filtering conditions from the input part 16, and cause to filter and display the displayed post data based on the acquired information relating to the filtering conditions. In case that displaying a plurality of post data, the control part 18 may cause to shift and display the post data so that the plurality of post data do not overlap each other; cause to display a list of post data icons; or cause to aggregate, organize and display how many post data have been posted at which point.

The server apparatus 30 is an apparatus that performs a service that provides information relating to post data to cause to overlap and display at a predetermined position in the image data displayed on the augmented reality display apparatuses 10A, 10B (see FIG. 1). The server apparatus 30 associates and stores information relating to the shooting position information, the shooting target object feature amounts, and the post data. The server apparatus 30 is communicably (wireless-communicably or wired-communicably) connected to the network 60. As the server apparatus 30, an apparatus (computer apparatus) comprising function parts (for example, a processor, a storage device, and a communication interface) configuring a server can be used, and, for example, a physical server, a virtual server, a cloud server, etc., may be used. The server apparatus 30 realizes a configuration comprising a communication part 31, a storage part 32, and a control part 33 by executing a predetermined program.

The communication part 31 is a function part that communicates (wired-communicates or wireless-communicates) information (see FIG. 1). The communication part 31 is communicably connected to the network 60. The communication part 31 performs communication under control of the control part 33. As the communication part 31, for example, a wired communication interface or a wireless communication interface may be used. The communication part 31 can receive the post upload instruction information, the post download instruction information, etc. from the augmented reality display apparatuses 10A, 10B. The communication part 31 can transmit information relating to the post data according to the post download instruction information to the augmented reality display apparatuses 10A, 10B.

The storage part 32 is a function part that stores various information (data, programs, etc.) (see FIG. 1). As the storage part 32, for example, a storage device such as a RAM, an SSD, an HDD, or a RAID (Redundant Array of Inexpensive Disks) can be used. The storage part 32 writes and reads information under control of the control part 33. The storage part 32 can store data from the augmented reality display apparatuses 10A, 10B. The storage part 32 can store data processed by the control part 33. The data stored in the storage part 32 can be transmitted to the augmented reality display apparatuses 10A, 10B. The storage part 32 can store the shooting position information, the shooting target object feature amount, and information relating to the post data in association with each other.

The control part 33 is a function part that controls the communication part 31 and the storage part 32 (see FIG. 1). As the control part 33, for example, a processor such as a CPU or an MPU can be used. The control part 33 can perform predetermined information processing described in a predetermined program by executing the predetermined program stored in the storage part 32.

Upon registering post data, the control part 33 acquires the post upload instruction information from the augmented reality display apparatuses 10A, 10B via the network 60 and the communication part 31. The control part 33 causes the storage part 32 to store the shooting position information included in the acquired post upload instruction information, the shooting target object feature amount, and the information relating to the post data in association with each other. Upon the post data is registered, the control part 33 may notify the augmented reality display apparatuses 10A, 10B of followers who are following a poster (followee) of the post data, that the post data has been registered.

Upon providing (including a case of filtering and providing) post data, the control part 33 performs the following processings. The control part 33 acquires the post download instruction information (in case of filtering, information also associated with information relating to filtering conditions) from the augmented reality display apparatuses 10A, 10B via the network 60 and the communication part 31. The control part 33 acquires information relating to the post data corresponding to the shooting target object feature amount that is located within a predetermined range of a position relating to the shooting position information included in the acquired post download instruction information and that is included in the post download instruction information from the storage part 32. In case that the acquired post download instruction information includes information relating to filtering conditions, the control part 33 acquires information relating to post data corresponding to information relating to the filtering conditions among the information relating to the post data corresponding to the shooting position information and shooting target object feature amount included in the acquired post download instruction information from the storage part 32. The control part 33 transmits information relating to the acquired post data via the communication part 31 and the network 60 to the augmented reality display apparatuses 10A, 10B that have transmitted the post download instruction information.

The management apparatus 40 is an apparatus used to manage information relating to the post data stored in the server apparatus 30 (see FIG. 1). The management apparatus 40 is communicably (wireless-communicably or wired-communicably) connected to the network 60. As the management apparatus 40, an apparatus (computer apparatus) comprising function parts (for example, a processor, a storage device, an input device, a communication interface, and a display apparatus) that configure a computer can be used, and, for example, a personal computer, a tablet terminal, a smartphone, etc. can be used. The management apparatus 40 is used by an administrator of the server apparatus 30. The management apparatus 40 can delete information relating to the user ID, post data, etc. on a page dedicated to the administrator by operation of the administrator.

The network 60 is a wired or wireless communication network that communicably connects the augmented reality display apparatuses 10A, 10B, the server apparatus 30, and the management apparatus 40 (see FIG. 1). As the network 60, for example, a communication network such as a PAN (Personal Area Network), a LAN (Local Area Network), a MAN (Metropolitan Area Network), a WAN (Wide Area Network), or a GAN (Global Area Network) can be used.

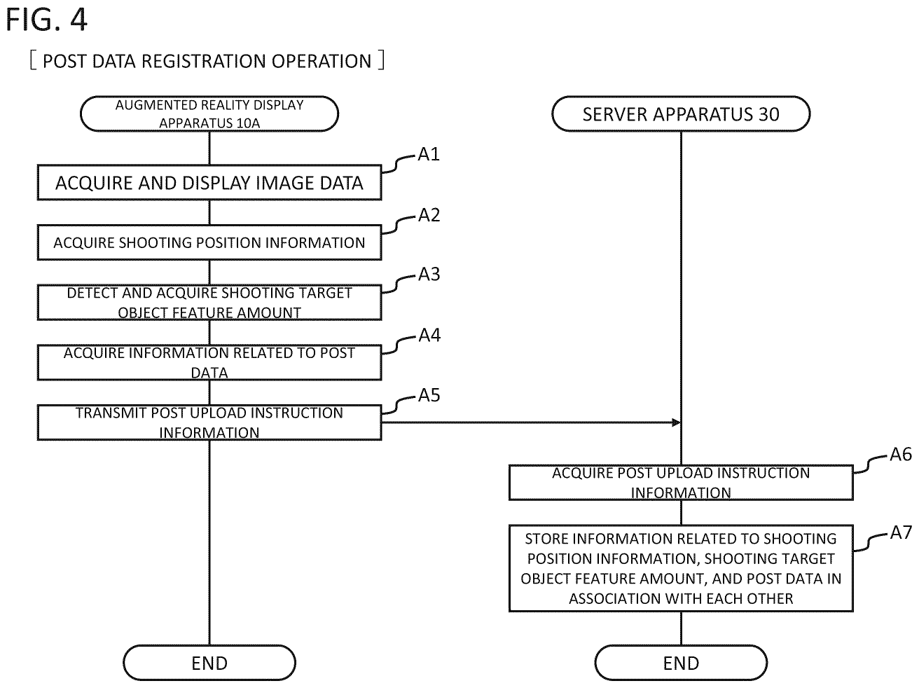

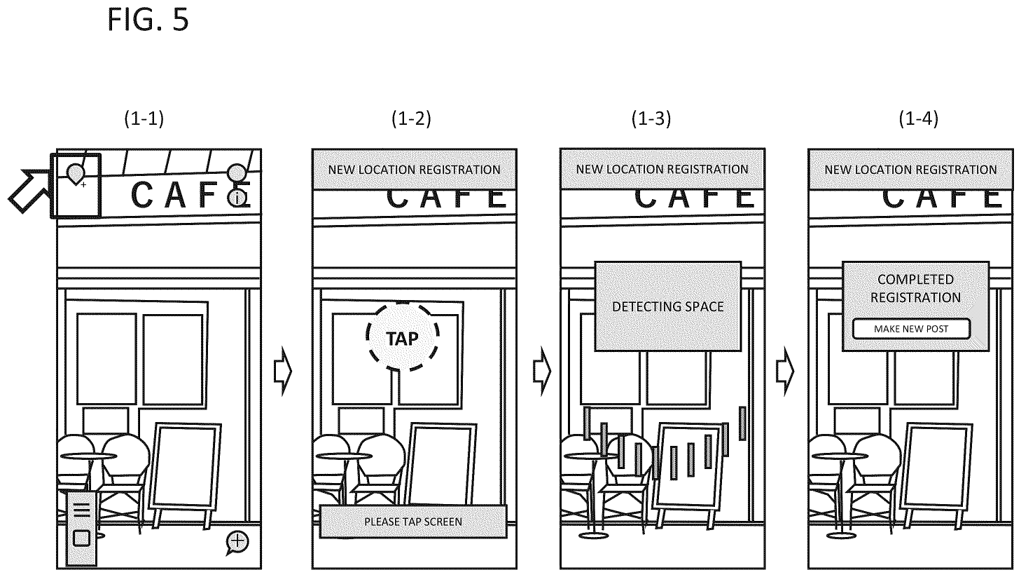

Operations relating to registration of post data in the augmented reality display system according to the example embodiment 1 will be explained using drawings. FIG. 4 is a flowchart diagram schematically showing operations relating to registration of post data in the augmented reality display system according to the example embodiment 1. FIGS. 5 to 7 are transition diagrams schematically showing examples of display screens of the augmented reality display apparatus upon registering post data in the augmented reality display system according to the example embodiment 1. As to the configuration of the augmented reality display system, please see FIG. 1.

First, the control part 18 of the augmented reality display apparatus 10A acquires image data from the imaging part 13 and causes the display part 12 to display the image data in response to operation of a user (step A1). The image data may be acquired from the storage part 17, the communication part 11 (the communication part 11 connected to outside), or the like.

Next, the control part 18 of the augmented reality display apparatus 10A acquires shooting position information from the position detection part 15 in response to operation of the user (step A2). In case that the shooting position information cannot be acquired from the position detection part 15, the process ends. In case that the image data is image data acquired from the storage part 17, the communication part 11, etc., the shooting position information included in the image data is acquired. In case that the image data acquired from the storage part 17, the communication part 11, etc. does not include shooting position information, the process ends. In step A2, for example, in case that the display screen of the augmented reality display apparatus is a display screen as shown in FIG. 5 (1-1), by tapping the “POST REGISTRATION” button, the shooting position information is acquired, and when the acquisition of the shooting position information is completed, the display screen changes to a display screen as shown in FIG. 5 (1-2).

Next, in response to operation of the user, the control part 18 of the augmented reality display apparatus 10A causes the image analysis part 14 to detect a shooting target object feature amount digitizing at least one feature point of the shooting target object 2 based on the acquired image data and acquires the detected shooting target object feature amount (step A3). In case that it is not possible to acquire the shooting target object feature amount, the process ends. In step A3, for example, in case that the display screen of the augmented reality display apparatus is a display screen as shown in FIG. 5 (1-2), by tapping the screen, the display screen changes to a display screen as shown in FIG. 5 (1-3); the augmented reality display apparatus 10A (imaging part 13) is moved so as to go around the side of the shooting target object 2 to acquire the shooting target object feature amount; and when the acquisition of the shooting target object feature amount is completed, the display screen changes to a display screen as shown in FIG. 5 (1-4). In acquiring of the shooting target object feature amount, at least one feature point in the image data (planes, edges, corners, etc. of walls and floors, etc.) is detected; a coordinate of a space relating to the image data is determined based on the extracted feature point; and it is possible to detect the shooting target object feature amount digitizing the feature point based on the determined coordinate.

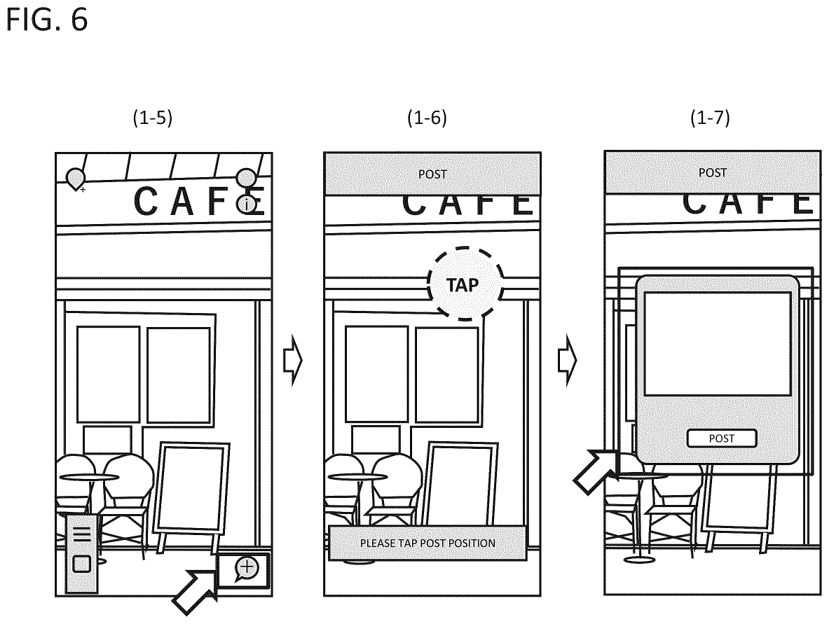

Next, the control part 18 of the augmented reality display apparatus 10A acquires information relating to post data from the input part 16 in response to operation of the user (step A4). As the information relating to post data, text, photo, post position (location) information, etc. are listed (see above for details). In step A4, for example, in case that the display screen of the augmented reality display apparatus is as shown in FIG. 6 (1-5), by tapping “+” button, the display screen changes a display screen as shown in FIG. 6 (1-6); by tapping a place, at which the user wants to post, to set a position, the display screen changes a display screen as shown in FIG. 6 (1-7); by selecting a post screen, the display screen changes a display screen as shown in FIG. 7 (1-8); by inputting post text to tap “POST” button, the display screen changes a display screen shown in FIG. 7 (1-9); by tapping “ADJUST POST POSITION” button to adjust the post position, the display screen changes a display screen shown in FIG. 7 (1-10); and by tapping the “POST AT THIS LOCATION” button, information relating to the post data can be acquired.

Next, the control part 18 of the augmented reality display apparatus 10A transmits post upload instruction information associated with the acquired shooting position information, shooting target object feature amount, and information relating to the post data in response to operation of the user, and transmits the to the server apparatus 30 via the communication part 11 and the network 60 (step A5).

Next, the control part 33 of the server apparatus 30 acquires the post upload instruction information from the augmented reality display apparatus 10A via the network 60 and the communication part 31 (step A6).

Next, the control part 33 of the server apparatus 30 causes the storage part 32 to store (register) the shooting position information, the shooting target object feature amount, and the information relating to the post data included in the acquired post upload instruction information in association with each other (step A7), and then ends.

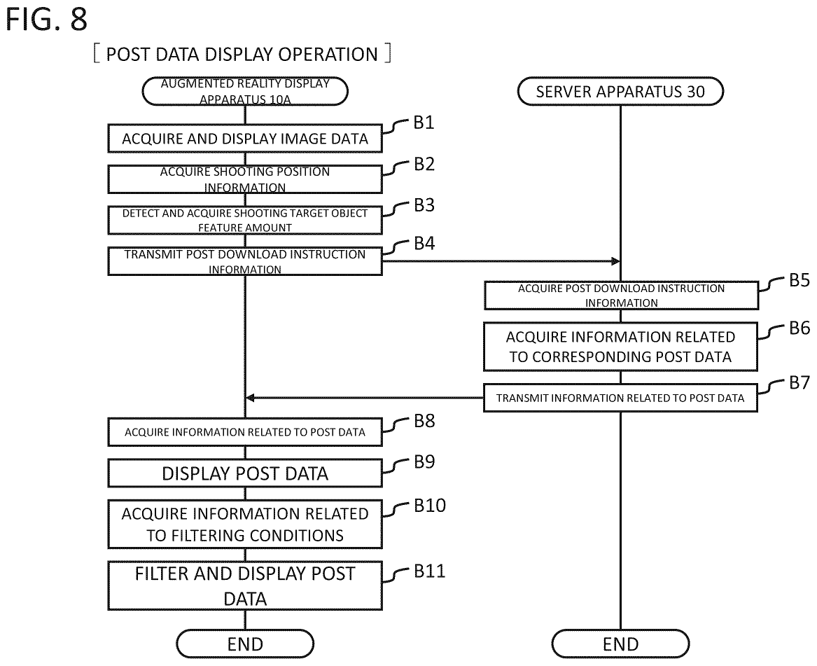

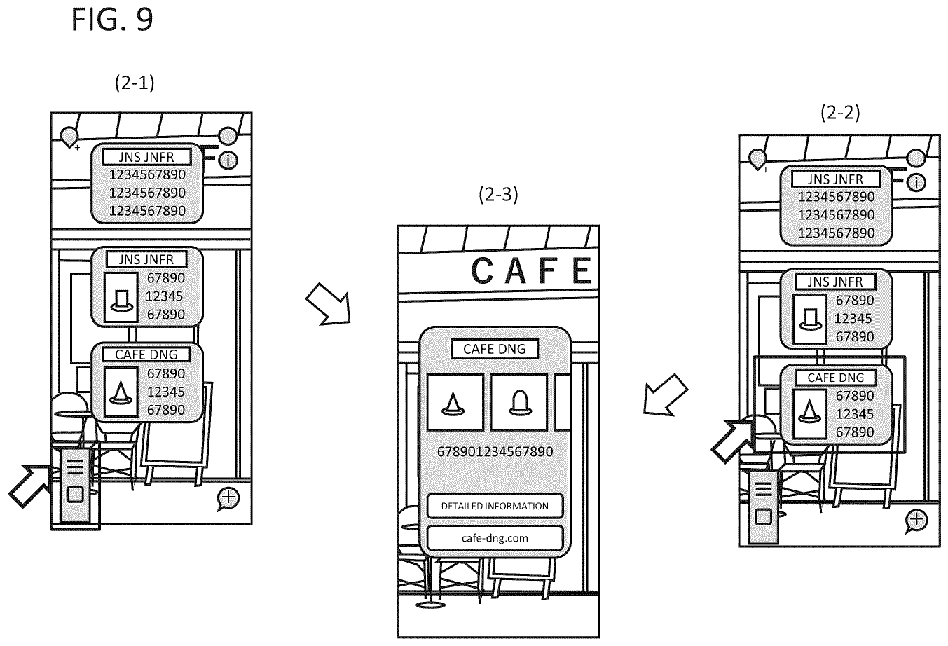

Operations relating to displaying post data in the augmented reality display system according to the example embodiment 1 will be explained using drawings. FIG. 8 is a flowchart diagram schematically showing operations relating to displaying post data in the augmented reality display system according to the example embodiment 1. FIG. 9 is a transition diagram schematically showing an example of display screen of the augmented reality display apparatus upon displaying post data in the augmented reality display system according to the example embodiment 1. As to the configuration of the augmented reality display system, please see FIG. 1.

First, the control part 18 of the augmented reality display apparatus 10A acquires image data from the imaging part 13 in response to operation of a user and displays the image data on the display part 12 (step B1). The image data may be acquired from the storage part 17, the communication part 11 (the communication part 11 connected to outside), or the like.

Next, the control part 18 of the augmented reality display apparatus 10A acquires shooting position information from the position detection part 15 in response to operation of the user (step B2). In case that the shooting position information cannot be acquired from the position detection part 15, the process ends. In case that the image data is image data acquired from the storage part 17, the communication part 11, etc., the shooting position information included in the image data is acquired. In case that the image data acquired from the storage part 17, the communication part 11, etc. do not include shooting position information, the process ends.

Next, the control part 18 of the augmented reality display apparatus 10A causes the image analysis part 14 to detect a shooting target object feature amount that digitizes at least one feature point of the shooting target object 2 based on the acquired image data in response to operation of the user and acquires the detected shooting target object feature amount (step B3). In case that it is not possible to acquire the shooting target object feature amount, the process ends.

Next, the control part 18 of the augmented reality display apparatus 10A transmits post download instruction information associating the acquired shooting position information and the shooting target object feature amount via the communication part 11 and the network 60 to the server apparatus 30 in response to operation of the user (step B4).

Next, the control part 33 of the server apparatus 30 acquires post download instruction information from the augmented reality display apparatuses 10A, 10B (step B5).

Next, the control part 33 of the server apparatus 30 acquires information relating to the post data corresponding to the shooting target object feature amount that is located within a predetermined range of a position relating to the shooting position information included in the acquired post download instruction information and is included in the post download instruction information, from the storage part 32 (step B6).

Next, the control part 33 of the server apparatus 30 transmits information relating to the acquired post data to the augmented reality display apparatuses 10A, 10B that have transmitted the post download instruction information via the communication part 31 and the network 60 (step B7).

Next, the control part 18 of the augmented reality display apparatus 10A acquires information relating to the post data transmitted from the server apparatus 30 that received the post download instruction information via the network 60 and the communication part 11 (step B8).

Next, the control part 18 of the augmented reality display apparatus 10A causes to overlay the post data at a relative position (position based on the post position information in the information relating to the post data) for the shooting target object feature amount in the image data displayed on the display part 12 based on the acquired information relating to the post data (step B9).

After that, in case of filtering and displaying post data, the control part 18 of the augmented reality display apparatus 10A acquires information relating to filtering conditions from the input part 16 in response to operation of the user (step B10). As the information relating to filtering conditions, for example, poster, posting time, hashtag, etc. are listed (see above for details). In step B10, for example, in case that the display screen of the augmented reality display apparatus is a display screen as shown in FIG. 9 (2-1) in which multiple pieces of post data are displayed in a reduced size, information relating to filtering conditions can be acquired by tapping the filtering condition input button and inputting information relating to the filtering conditions.

Next, the control part 18 causes to filter and display the displayed post data based on the acquired information relating to the filtering conditions (step B11), and then ends. In step B11, for example, it is possible to cause to transit from the display screen as shown in FIG. 9 (2-1) in which a plurality of post data are displayed in a reduced size to the display screen as shown in FIG. 9 (2-3) by the acquired information relating to the filtering conditions. Also, instead of filtering, by tapping the post data to which the user wants to refer to on the display screen as shown in FIG. 9 (2-2) in which a plurality of post data are displayed in a reduced size, it is possible to transit to a display screen as shown in FIG. 9 (2-3) on which the tapped post data is enlarged and displayed.

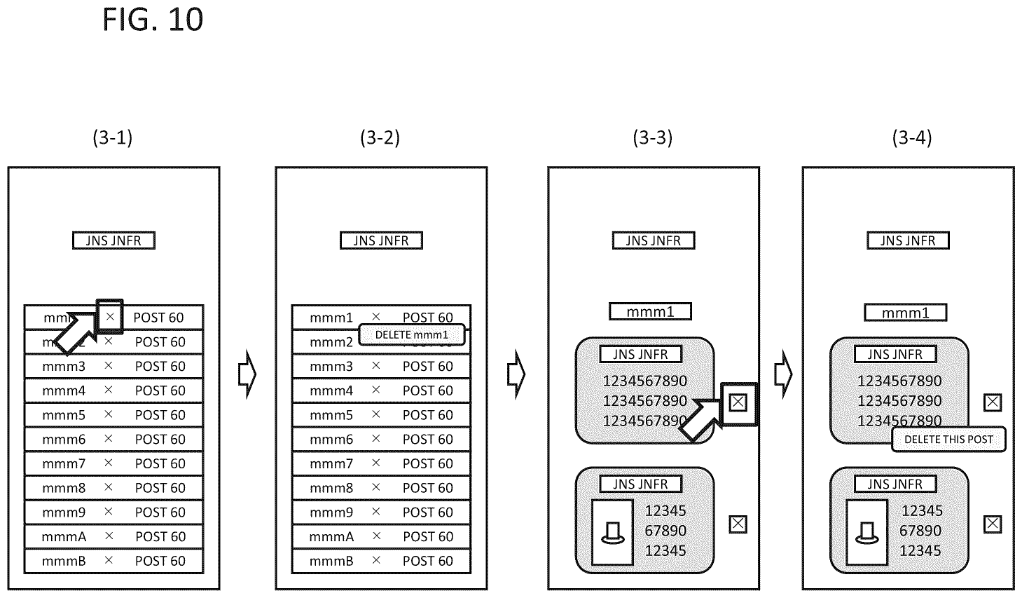

Operations upon deleting post data in the augmented reality display system according to the example embodiment 1 will be explained using drawings. FIG. 10 is a transition diagram schematically showing an example of display screen of the management apparatus upon deleting post data in the augmented reality display system according to the example embodiment 1. As to the configuration of the augmented reality display system, please see FIG. 1.

Upon the administrator deletes post data, the management apparatus 40 opens a page dedicated to the administrator and can delete user ID, information relating to post data, etc. by operation of the administrator. For example, when displaying a screen as shown in FIG. 10 (3-1) that lists icons of a plurality of post data for a predetermined user ID (JNS JNFR) on the page dedicated to the administrator, by tapping the icon of the post data that the administrator wants to delete, the screen transits to a screen as shown in FIG. 10 (3-2); transits to a screen as shown in FIG. 10 (3-3) on which it is possible to check a content of the post data; and transits to a screen as shown in FIG. 10 (3-4) by tapping a delete button, thereby it is possible to delete the post data.

According to the example embodiment 1, since the post data is overlayed on the image data using not only the shooting position information but also the shooting target object feature amount, it is possible to contribute to causing to display the post data at an accurate position in a shot image data.

Also, according to the example embodiment 1, by performing matching based on the shooting position information and the shooting target object feature amount, the search range is limited, and it is possible to quickly find post data that should be displayed on the displayed image data.

Further, according to the example embodiment 1, even in case a large number of post data are displayed in image data, by displaying a list of data or collectively and organizedly displaying data through inputting information relating to filtering conditions, it is possible to make it easier to find information that the user wants among the miscellaneous information, thereby it is possible to contribute to increasing customer satisfaction.

### Example Embodiment 2

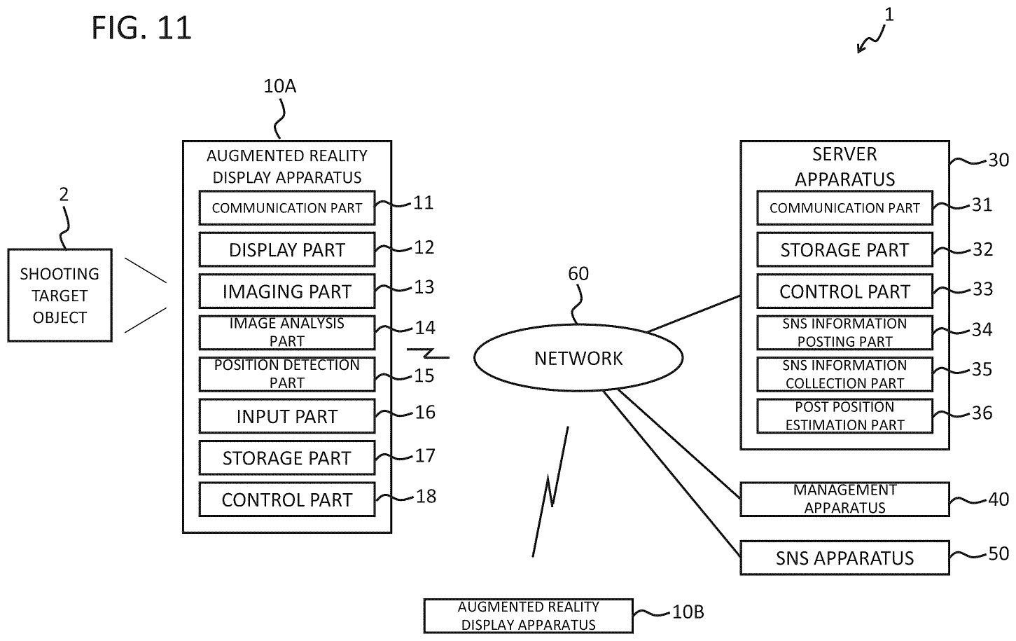

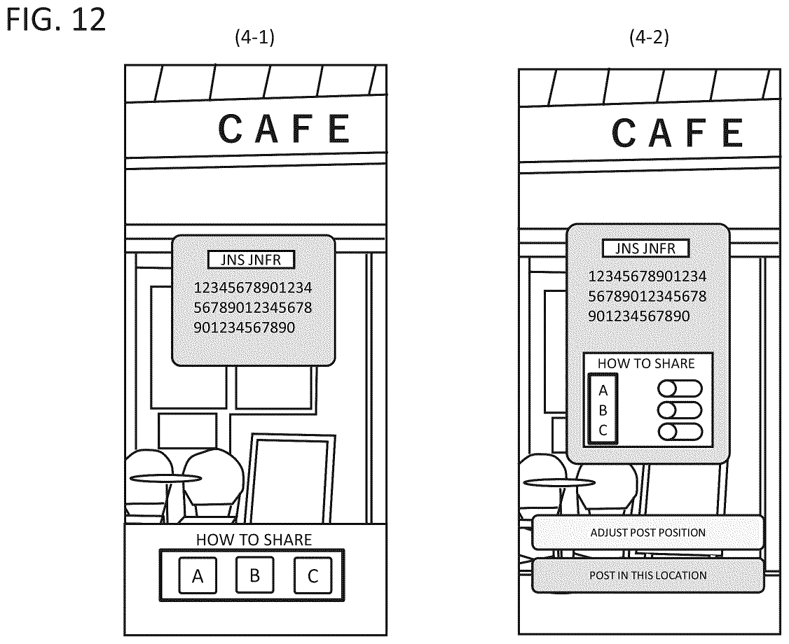

An augmented reality display system according to an example embodiment 2 will be explained using drawings. FIG. 11 is a block diagram schematically showing a configuration of the augmented reality display system according to the example embodiment 2. FIG. 12 is a transition diagram schematically showing an example of display screen of the augmented reality display apparatus upon post data in the augmented reality display system according to the example embodiment 2 is linked with an SNS.

The example embodiment 2 is a modification of the example embodiment 1 and is configured so that post data is linked with an SNS thereby post data can be shared between a server apparatus 30 and an SNS apparatus 50 (see FIG. 11). In the augmented reality display system 1 according to the example embodiment 2, to the augmented reality display system (1 in FIG. 1) according to the example embodiment 1, an SNS information posting part 34, an SNS information collection part 35, and the post position estimation part 36 are added in the server apparatus 30, and an SNS apparatus 50 is also added.

As embodiments of sharing post data between the server apparatus 30 and the SNS apparatus 50, there are an embodiment of sharing post data registered in the server apparatus 30 with the SNS apparatus 50 and an embodiment of sharing post data (post data including image data and shooting position information) registered in the SNS apparatus 50 with the server apparatus 30.

In the embodiment of sharing post data registered in the server apparatus 30 with the SNS apparatus 50, upon acquiring the information relating to the post data in step A4 of FIG. 4, the augmented reality display apparatuses 10A, 10B acquire Selection information of shared SNS for selecting an SNS to be shared. The augmented reality display apparatuses 10A, 10B include the acquired Selection information of shared SNS in information relating to the post data and transmit the information to the server apparatus 30. For example, upon acquiring information relating to post data on the augmented reality display apparatuses 10A, 10B, a button relating to a sharing method for sharing with an SNS is displayed on a display screen as shown in FIG. 12 (4-1); by tapping a button, the display screen transits to a display screen as shown in FIG. 12 (4-2) for selecting the SNS to be shared; and by selecting the SNS to be shared, the Selection information of shared SNS can be included in the information relating to the post data. The SNS information posting part 34 of the server apparatus 30 acquires information relating to the post data included in the post upload instruction information from the augmented reality display apparatuses 10A, 10B; generates SNS information post information for posting the SNS information to the SNS apparatus 50 based on the acquired the information relating to the post data; and transmits the generated SNS information post information to the SNS apparatus 50 relating to the SNS selected by the Selection information of shared SNS. Also, even in case that the information relating to the post data does not include the Selection information of shared SNS, the SNS information posting part 34 may be configured to generate SNS information post information based on the information relating to the post data acquired from the augmented reality display apparatuses 10A, 10B and transmit the generated SNS information post information to the SNS apparatus 50 relating to an arbitrary SNS. The SNS apparatus 50 acquires the SNS information post information from the server apparatus 30 and registers SNS information based on the acquired SNS information post information. As a result, it becomes possible to refer to the SNS information relating to the posted data posted in the augmented reality display apparatuses 10A, 10B on the SNS relating to the SNS apparatus 50, and it becomes possible to access and refer to the post data (posted data posted in augmented reality display apparatuses 10A, 10B) registered in the server apparatus 30.

In an embodiment of sharing post data (post data including image data and shooting position information) registered in the SNS apparatus 50 with the server apparatus 30, the SNS information collection part 35 of the server apparatus 30 collects the post data (post data including image data and shooting position information) registered in the SNS apparatus 50 from the SNS apparatus 50; selects SNS information including at least image data and shooting position information among the collected SNS information. The post position estimation part 36 of the server apparatus 30 detects shooting target object feature amount (three-dimensional coordinate information, coordinate polar information, etc.) digitizing at least one feature point of the shooting target object 2 based on the image data included in the selected SNS information. The post position estimation part 36 acquires the information relating to the post data that is located within a predetermined range of a position relating to the shooting position information included in the selected SNS information and that corresponds to the detected shooting target object feature amount from the storage part 32. The post position estimation part 36 compares hashtag or text included in the acquired information relating to the post data with the hashtag or text included in the selected SNS information to extract information relating to matching post data. The post position estimation part 36 extracts the post position information included in the information relating to the extracted post data and generates post position information relating to a position near the extracted post position information. The post position estimation part 36 generates post data for the server apparatus 30 based on the extracted SNS information; associates the generated post position information with the generated post data to generate information relating to the post data according to the SNS information. The post position estimation part 36 causes the storage part 32 to store (register) the generated information relating to the post data, the extracted shooting position information according to the SNS information, and the detected shooting target object feature amount (the extracted shooting target object feature amount according to the SNS information) in association with each other. Thereby, it becomes possible to access and refer to the post data (the post data according to the SNS information) registered in the server apparatus 30.

Other configurations and operations of the augmented reality display system 1 according to the example embodiment 2 are similar to those of the augmented reality display system according to the example embodiment 1.

According to the example embodiment 2, similarly to the example embodiment 1, since causing to overlay the post data in the image data using not only the shooting position information but also the shooting target object feature amount, it is possible to contribute to causing to display the post data at an accurate position in a shot image data.

Also, according to the example embodiment 2, since the post data for an augmented reality image registered in the server apparatus 30 can be registered in the SNS apparatus 50 as SNS information, it is possible to increase chances of viewing the post data registered in the server apparatus 30.

Further, according to the example embodiment 2, since the post data for an augmented reality image is registered in the server apparatus 30 based on the SNS information registered in the SNS apparatus 50, it is possible to increase information amount registered in the server apparatus 30 and it is possible to make it easier for a user to obtain information that the user needs.

### Example Embodiment 3

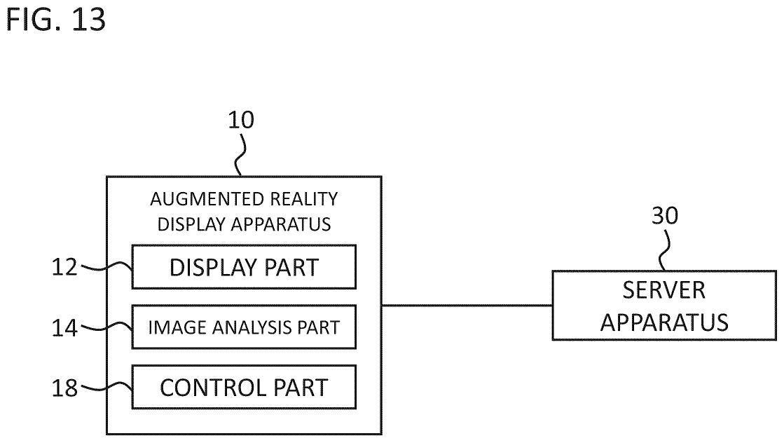

An augmented reality display apparatus according to an example embodiment 3 will be explained using drawings. FIG. 13 is a block diagram schematically showing a configuration of the augmented reality display apparatus according to the example embodiment 3.

The augmented reality display apparatus 10 is an apparatus that displays augmented reality images (see FIG. 13). The augmented reality display apparatus 10 is communicably connected to the server apparatus 30. The augmented reality display apparatus 10 comprises a display part 12, an image analysis part 14, and a control part 18.

The display part 12 is configured to display information. The image analysis part 14 is configured to analyze image data and detect a shooting target object feature amount that digitizes at least one feature point of a shooting target object included in the image data. The control part 18 is configured to control the display part and the image analysis part and perform predetermined information processing.

The control part 18 performs a process of transmitting post download instruction information including shooting position information relating to a shooting position of the image data and the shooting target object feature amount to a server apparatus 30. The control part 18 performs a process of causing the display part 12 to overlay the post data at a relative position to the shooting target object feature amount in the image data displayed on the display part 12 based on information relating to the post data associated with the shooting position information and the shooting target object feature amount transmitted from the server apparatus 30. Here, the relative position to the shooting target object feature amount is a position based on the post position information included in the information relating to the post data.

According to the example embodiment 3, since causing to overlay the post data in the image data using not only the shooting position information but also the shooting target object feature amount, it is possible to contribute to causing to display the post data at an accurate position in a shot image data.

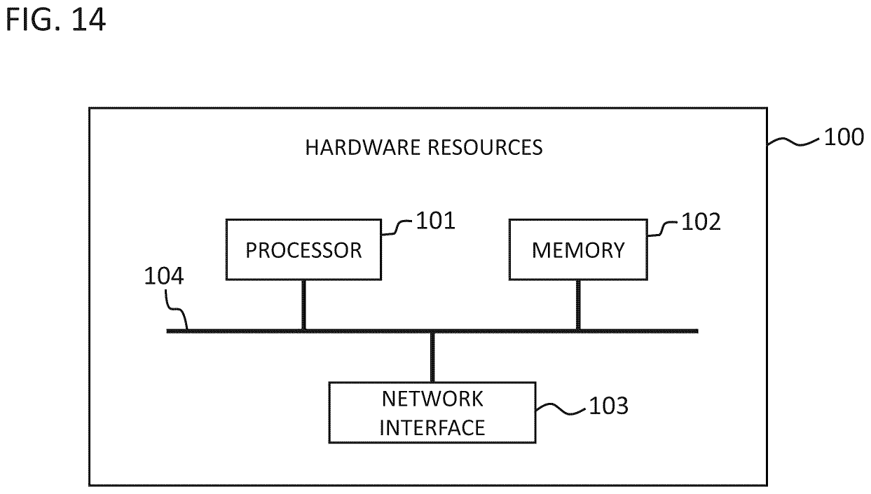

The augmented reality display apparatus and the server apparatus according to the example embodiments 1 to 3 can be configured by so-called hardware resources (information processing apparatus, computer), and it is possible to use one comprising a configuration illustrated in FIG. 14. For example, the hardware resources 100 comprises a processor 101, a memory 102, a network interface 103, etc., which are interconnected by an internal bus 104.

Note that the configuration shown in FIG. 14 is not intended to limit a hardware configuration of the hardware resources 100. The hardware resources 100 may include hardware (for example, an input/output interface) that is not shown. Alternatively, the number of units such as the processors 101 included in the apparatus is not limited to the example shown in FIG. 14, for example, a plurality of processors 101 may be included in the hardware resources 100. As the processor 101, for example, a CPU (Central Processing Unit), an MPU (Micro Processor Unit), a GPU (Graphics Processing Unit), etc. can be used.

As the memory 102, for example, a RAM (Random Access Memory), an HDD (Hard Disk Drive), an SSD (Solid State Drive), etc. can be used.

As the network interface 103, for example, a LAN (Local Area Network) card, a network adapter, a network interface card, etc. can be used.

The functions of the hardware resources 100 are realized by the processing modules described above. The processing module is realized, for example, by the processor 101 executing a program stored in the memory 102. Also, the program can be downloaded via a network or updated using a storage medium storing the program. Further, the processing module may be realized by a semiconductor chip. That is, It is sufficient if the functions performed by the processing module can be realized by executing software on some kind of hardware.

A part or all of the above example embodiments may be described as the following Modes but is not limited to the following.

### [Mode 1]

An augmented reality display apparatus, comprising:
a display part configured to display information;
an image analysis part configured to analyze image data and detect a shooting target object feature amount that digitizes at least one feature point of a shooting target object included in the image data;
a control part configured to control the display part and the image analysis part and perform predetermined information processing,
wherein the control part is configured to perform processings of:
transmitting post download instruction information including shooting position information relating to a shooting position of the image data and the shooting target object feature amount to a server apparatus; and causing the display part to overlay the post data at a relative position to the shooting target object feature amount in the image data displayed on the display part based on information relating to the post data associated with the shooting position information and the shooting target object feature amount transmitted from the server apparatus, and wherein the relative position to the shooting target object feature amount is a position based on the post position information included in the information relating to the post data.

### [Mode 2]

The augmented reality display apparatus according to Mode 1, further comprising an input part configured to input information by operation of a user,
wherein the control part is configured further to perform a processing of transmitting post upload instruction information including the shooting position information, the shooting target object feature amount, and information relating to the post data input from the input part to the server apparatus.

### [Mode 3]

The augmented reality display apparatus according to Mode 2, wherein the information relating to the post data includes Selection information of shared SNS that selects an SNS to be shared.

### [Mode 4]

The augmented reality display apparatus according to Mode 2 or 3, wherein upon causing the display part to display the post data, the control part filters the post data and causes the display part to display the filtered post data based on information relating to a filtering condition input from the input part.

### [Mode 5]

The augmented reality display apparatus according to any one of Modes 1 to 4, further comprising:
an imaging part configured to generate the image data by shooting the shooting target object; and
a position detection part configured to detect the shooting position information.

### [Mode 6]

The augmented reality display apparatus according to any one of Modes 1 to 5, further comprising a communication part configured to acquire the image data associated with the shooting position information from outside.

### [Mode 7]

The augmented reality display apparatus according to any one of Modes 1 to 6, further comprising a storage part that stores the image data associated with the shooting position information.

### [Mode 8]

A server apparatus, comprising:
a storage part configured to associate and store: shooting position information relating to a position at which image data was shot; a shooting target object feature amount that digitizes at least one feature point of a shooting target object included in the image data; and information relating to post data including post position information relating to a relative position to the shooting target object feature amount; and
a control part configured to control the storage part and perform a predetermined information processing,
wherein when acquiring post download instruction information from an augmented reality display apparatus, the control part is configured to perform processings of: reading information relating to the post data associated with shooting position information and shooting target object feature amount included in the post download instruction information from the storage part; and transmitting the read information to the augmented reality display apparatus.

### [Mode 9]

The server apparatus according to Mode 8,
wherein when acquiring post upload instruction information from the augmented reality display apparatus, the control part is configured further to perform processings of: associating shooting position information included in the post upload instruction information, shooting target object feature amount, and information relating to the post data; and causing the storage part to store the associated information.

### [Mode 10]

The server apparatus according to Mode 9, further comprising an SNS information posting part that generates SNS information post information for posting SNS information to an SNS apparatus based on information relating to the post data included in the post upload instruction information and transmits the SNS information post information to the SNS apparatus.

### [Mode 11]

The server apparatus according to any one of Modes 8 to 10, further comprising:
an SNS information collection part that collects SNS information from an SNS apparatus; and
a post position estimation part that estimates post position information of the SNS information based on image data and shooting position information included in the SNS information,
wherein the post position estimation part is configured to perform processings of:
detecting a shooting target object feature amount digitizing at least one feature point of a shooting target object based on the image data included in the SNS information;
acquiring information relating to post data that is located within a predetermined range from a position of the shooting position information included in the SNS information and that is associated with the detected shooting target object feature amount, from the storage part;
comparing hashtag or text included in the acquired information relating to the post data with hashtag or text included in the SNS information to extract information relating to matching post data;
generating post position information relating to a position near a position of the post position information included in the information relating to the extracted post data;
generating post data for the server apparatus based on the SNS information;
associating the generated post position information with the generated post data to generate information relating to post data associated with the SNS information; and
associating information relating to the generated post data, the shooting position information included in the SNS information, and the detected shooting target object feature amount to cause the storage part to store the associated information.

### [Mode 12]

An augmented reality display system, comprising:
the augmented reality display apparatus according to any one of Modes 1 to 7; and
the server apparatus according to any one of Modes 8 to 11.

### [Mode 13]

The augmented reality display system according to Mode 12, further comprising an SNS apparatus configured to be communicably connected to the server apparatus.

### [Mode 14]

An augmented reality display method, comprising:
transmitting post download instruction information including shooting position information relating to a shooting position of an image data, and post download instruction information including a shooting target object feature amount obtained by analyzing the image data and digitizing at least one feature point of a shooting target object included in the image data, from an augmented reality display apparatus to a server apparatus;
reading information relating to post data associated with the shooting position information and the shooting target object feature amount included in the post download instruction information from a storage part of the server apparatus, when acquiring the post download instruction information, to transmit the read information to the augmented reality display apparatus, in the server apparatus; and
causing the augmented reality display apparatus to overlay the post data at a relative position to the shooting target object feature amount in the displayed image data based on information relating to the post data transmitted from the server apparatus,
wherein the relative position to the shooting target object feature amount is a position based on the post position information included in the information relating to the post data.

### [Mode 15]

A program, causing an augmented reality display apparatus to execute processings of:
transmitting post download instruction information including shooting position information relating to a shooting position of an image data, and a shooting target object feature amount obtained by analyzing the image data and digitizing at least one feature point of a shooting target object included in the image data, to a server apparatus; and
causing to overlay the post data at a relative position to the shooting target object feature amount in the displayed image data based on information relating to post data associated with the shooting position information and the shooting target object feature amount transmitted from the server apparatus,
wherein the relative position to the shooting target object feature amount is a position based on the post position information included in the information relating to the post data.

### [Mode 16]

A program, causing a server apparatus to execute processings of:
reading information relating to post data associated with shooting position information and shooting target object feature amount included in post download instruction information from a storage part, when acquiring post download instruction information from an augmented reality display apparatus; and
transmitting the read information to the augmented reality display apparatus.

It is deemed that the disclosure of each PTL cited above is incorporated and described herein by reference and can be used as a basis or a part of the present invention as needed. Within a framework of the entire disclosure of the present invention (including claims and drawings), it is possible further to modify or adjust the example embodiments or examples based on the basic technical idea thereof. Also, within the framework of entire disclosure of the present invention, various combinations or selections (non-selection if necessary) of various disclosed elements (including each element of each claim, each element of each example embodiment or example, each element of each drawing, etc.) is possible. That is, it goes without saying that the present invention includes various deformations and modifications that can be made by one skilled in the art in accordance with all disclosures including claims and drawings, and the technical concept. Further, as to the numerical values and numerical ranges described in the present application, it is considered that arbitrary intermediate values, lower numerical values, and small ranges are described even if not explicitly recited. Furthermore, it is also considered that a matter used to combine part or all of each of the disclosed matters of the above-cited documents with the matters described in this document as a part of the disclosure of the present invention, in accordance with the gist of the present invention, if necessary, is included in the disclosed matters of the present application.

### REFERENCE SIGNS LIST

1 Augmented reality display system
2. Shooting target object
10, 10A, 10B Augmented reality display apparatus
11 Communication part
12 Display part
13 Imaging part
14 Image analysis part
15 Position detection part
16 Input part
17 Storage part
18 Control part
30 Server apparatus
31 Communication part
32 Storage part
33 Control part
34 SNS information posting part
35 SNS information collection part
36 Post position estimation part
40 Management apparatus
50 SNS apparatus
60 Network
100 Hardware resources
101 Processor
102 Memory
103 Network interface
104 Internal bus

What is claimed is:

1. An augmented reality display apparatus, comprising:
a display part configured to display information;
an image analysis part configured to analyze image data and detect a shooting target object feature amount that digitizes at least one feature point of a shooting target object included in the image data;
a control part configured to control the display part and the image analysis part and perform predetermined information processing,
wherein the control part is configured to perform processings of:
transmitting post download instruction information including shooting position information relating to a shooting position of the image data and the shooting target object feature amount to a server apparatus; and
causing the display part to overlay the post data at a relative position to the shooting target object feature amount in the image data displayed on the display part based on information relating to the post data associated with the shooting position information and the shooting target object feature amount transmitted from the server apparatus, and
wherein the relative position to the shooting target object feature amount is a position based on the post position information included in the information relating to the post data.

2. The augmented reality display apparatus according to claim 1, further comprising an input part configured to input information by operation of a user,
wherein the control part is configured further to perform a processing of transmitting post upload instruction information including the shooting position information, the shooting target object feature amount, and information relating to the post data input from the input part to the server apparatus.

3. The augmented reality display apparatus according to claim 2,
wherein the information relating to the post data includes Selection information of shared SNS that selects an SNS to be shared.

4. The augmented reality display apparatus according to claim 2,
wherein upon causing the display part to display the post data, the control part filters the post data and causes the display part to display the filtered post data based on information relating to a filtering condition input from the input part.

5. The augmented reality display apparatus according to claim 1, further comprising:
an imaging part configured to generate the image data by shooting the shooting target object; and
a position detection part configured to detect the shooting position information.

6. The augmented reality display apparatus according to claim 1, further comprising a communication part configured to acquire the image data associated with the shooting position information from outside.

7. The augmented reality display apparatus according to claim 1, further comprising a storage part that stores the image data associated with the shooting position information.

8. A server apparatus, comprising:
a storage part configured to associate and store: shooting position information relating to a position at which image data was shot; a shooting target object feature amount that digitizes at least one feature point of a shooting target object included in the image data; and information relating to post data including post position information relating to a relative position to the shooting target object feature amount; and
a control part configured to control the storage part and perform a predetermined information processing,
wherein when acquiring post download instruction information from an augmented reality display apparatus, the control part is configured to perform processings of: reading information relating to the post data associated with shooting position information and shooting target object feature amount included in the post download instruction information from the storage part; and transmitting the read information to the augmented reality display apparatus.

9. The server apparatus according to claim 8,
wherein when acquiring post upload instruction information from the augmented reality display apparatus, the control part is configured further to perform processings of: associating shooting position information included in the post upload instruction information, shooting target object feature amount, and information relating to the post data; and causing the storage part to store the associated information.

10. The server apparatus according to claim 9, further comprising an SNS information posting part that generates SNS information post information for posting SNS information to an SNS apparatus based on information relating to the post data included in the post upload instruction information and transmits the SNS information post information to the SNS apparatus.

11. The server apparatus according to claim 8, further comprising:
an SNS information collection part that collects SNS information from an SNS apparatus; and
a post position estimation part that estimates post position information of the SNS information based on image data and shooting position information included in the SNS information,
wherein the post position estimation part is configured to perform processings of:
detecting a shooting target object feature amount digitizing at least one feature point of a shooting target object based on the image data included in the SNS information;
acquiring information relating to post data that is located within a predetermined range from a position of the shooting position information included in the SNS information and that is associated with the detected shooting target object feature amount, from the storage part;
comparing hashtag or text included in the acquired information relating to the post data with hashtag or text included in the SNS information to extract information relating to matching post data;
generating post position information relating to a position near a position of the post position information included in the information relating to the extracted post data;
generating post data for the server apparatus based on the SNS information;
associating the generated post position information with the generated post data to generate information relating to post data associated with the SNS information; and
associating information relating to the generated post data, the shooting position information included in the SNS information, and the detected shooting target object feature amount to cause the storage part to store the associated information.

12. An augmented reality display system, comprising:
the augmented reality display apparatus according to claim 1; and
a server apparatus,
wherein the server apparatus comprises:
a storage part configured to associate and store: shooting position information relating to a position at which image data was shot; a shooting target object feature amount that digitizes at least one feature point of a shooting target object included in the image data; and information relating to post data including post position information relating to a relative position to the shooting target object feature amount; and
a control part configured to control the storage part and perform a predetermined information processing,
wherein when acquiring post download instruction information from an augmented reality display apparatus, the control part is configured to perform processings of: reading information relating to the post data associated with shooting position information and shooting target object feature amount included in the post download instruction information from the storage part; and transmitting the read information to the augmented reality display apparatus.

13. The augmented reality display system according to claim 12, further comprising an SNS apparatus configured to be communicably connected to the server apparatus.

14. An augmented reality display method, comprising:
transmitting post download instruction information including shooting position information relating to a shooting position of an image data, and post download instruction information including a shooting target object feature amount obtained by analyzing the image data and digitizing at least one feature point of a shooting target object included in the image data, from an augmented reality display apparatus to a server apparatus;
reading information relating to post data associated with the shooting position information and the shooting target object feature amount included in the post download instruction information from a storage part of the server apparatus, when acquiring the post download instruction information, to transmit the read information to the augmented reality display apparatus, in the server apparatus; and
causing the augmented reality display apparatus to overlay the post data at a relative position to the shooting target object feature amount in the displayed image data based on information relating to the post data transmitted from the server apparatus,
wherein the relative position to the shooting target object feature amount is a position based on the post position information included in the information relating to the post data.

15.-16.

17. The augmented reality display apparatus according to claim 3,
wherein upon causing the display part to display the post data, the control part filters the post data and causes the display part to display the filtered post data based on information relating to a filtering condition input from the input part.

18. The augmented reality display apparatus according to claim 2, further comprising:
an imaging part configured to generate the image data by shooting the shooting target object; and
a position detection part configured to detect the shooting position information.

19. The augmented reality display apparatus according to claim 3, further comprising:
an imaging part configured to generate the image data by shooting the shooting target object; and
a position detection part configured to detect the shooting position information.

20. The augmented reality display apparatus according to claim 4, further comprising:
an imaging part configured to generate the image data by shooting the shooting target object; and
a position detection part configured to detect the shooting position information.

21. The augmented reality display apparatus according to claim 17, further comprising:
an imaging part configured to generate the image data by shooting the shooting target object; and
a position detection part configured to detect the shooting position information.

22. The augmented reality display apparatus according to claim 2, further comprising a communication part configured to acquire the image data associated with the shooting position information from outside.
